(19) United States
(12) Patent Application Publication
(10) Pub. No.: US 2017/0070050 A1
(43) Pub. Date: Mar. 9, 2017

(54) DISTRIBUTED POWER GENERATION SYSTEM

(71) Applicants: Zhenkun Wang, Ashburn, VA (US); Xiyou Wang, Ashburn, VA (US)

(72) Inventors: Zhenkun Wang, Ashburn, VA (US); Xiyou Wang, Ashburn, VA (US)

(21) Appl. No.: 15/048,477

(22) Filed: Feb. 19, 2016

(30) Foreign Application Priority Data
Sep. 7, 2015 (CN) 201520685698.5

(51) Int. Cl. H02J 3/38; G06Q 20/10

(52) U.S. Cl. CPC H02J 3/382; G06Q 20/10; H02J 3/383; H02J 3/386

(57) ABSTRACT

The present invention discloses a system and method for distributed power generation. The system comprises a power generation apparatus, a smart grid, and a bank. The power generation apparatus comprises an identification circuit, a personal generator, and an exercise equipment. The identification circuit identifies the user and the power generator converts user work into electricity. The power generation apparatus transmits the user's identity and generated electricity to the smart grid. The smart grid calculates a financial compensation according to the generated electricity and transmits the financial compensation according to the user identity.

### CROSS REFERENCE TO RELATED APPLICATION

This application claims priority to Chinese Patent Application No. 201520685698.5 filed in the Chinese Patent Office on Sep. 7, 2015, the entire content of which is incorporated herein by reference.

### BACKGROUND OF THE INVENTION

In today's economic environment, global energy demands are extremely high. As energy usage increases, energy production must meet market demands, and many of the sources of energy used in the production of electricity generate a great deal of pollution. In view of environmental considerations, a decline in usage of fossil fuels and other polluting sources of energy is required. Traditionally, the alternatives to fossil fuel for energy have come from geothermal power, hydroelectric power, solar power, wind power, or nuclear power.

In spite of the wide range of alternative sources of energy, fossil fuel derived power still accounts for a large proportion of the generated electricity, and thus still poses a challenge to the environment. In view of the threat of pollution and environmental harm, governments and business interests have begun searching for other means of generating power without increasing the existing levels of pollution.

On a smaller scale, there have been strides made in the development of small human-powered generators to produce electricity in order to power small devices. If this technology could be integrated with the electrical grid, in populous regions there will be great economic and environmental advantage to doing so. Fossil energy will eventually exhaust; therefore, only this set of systems can supply human generation inexhaustible supply of energy.

### BRIEF SUMMARY OF THE INVENTION

It is an object of the present invention to provide a distributed power generation system integrating individual identification technology.

According to an aspect of the present invention, individual identification technology is integrated with a power generation apparatus comprising a data transmission circuit, an identification circuit, and a power transmission circuit. The data transmission circuit and the power transmission circuit are connected to a smart electrical grid. The smart electrical grid is integrated with a processor and memory to retrieve user identification and assign financial compensation.

The power generation apparatus can comprise a stationary bicycle, hand-powered generator, a treadmill, or a foot-powered generator. The power generation apparatus can be any form of exercise equipment coupled to a personal generator.

In the above embodiment, the power generation apparatus determines the identity of the user via manual entry, Near-Field Communication (NFC), Radio Frequency Identification (RFID), magnetic stripe card, or other methods of providing a user identity. The identification information is transmitted via the data transmission circuit to the smart grid and informs the smart grid to register the power generated by the power generation apparatus to the user's financial identification, when the power generation apparatus is being operated by the user.

The smart grid will register the inputted electrical energy generated by the user to the user's financial information, so that payment or other financial compensation can be assigned to the user for the electricity generated. The smart grid will automatically assign financial compensation to the user accordingly.

The smart grid will be connected to a financial institution to automatically and directly transfer financial compensation to the user. Payment can be done by wire transfer, by debit card, by check, or other means of transferring money known in the art.

The power transmission circuit can be electrically coupled to the smart grid by wire for maximum transmission efficiency.

The data transmission circuit can be implemented by wired or wireless communication.

The identification circuit can be implemented by RFID, NFC, manual entry, magnetic stripe card, or other identification techniques known in the art. The identification circuit sends identification information via the data transmission circuit.

In order to further improve power generation efficiency, small generators via the power transmission cable with the device is connected, the identification device over the wireless communication apparatus communicating with the data transmission.

The above system will allow an individual user to generate electricity for a smart grid, which provides the user with exercise, reduce the electrical demands of the smart grid, and enable the user to be financially compensated.

The objects and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF THE SEVERAL VIEWS OF THE DRAWINGS

The above embodiments become more readily apparent to those ordinarily skilled in the art after reviewing the following detailed description and accompanying drawings, in which:

FIG. 1 is a flow chart of the distributed power generation system in accordance with an embodiment of the invention;

FIG. 2 is a diagram of a power generation apparatus in accordance with an embodiment of the invention.

FIG. 3 is a diagram of another power generation apparatus in accordance with an embodiment of the invention.

### DETAILED DESCRIPTION OF THE INVENTION

Aspects, features and advantages of several exemplary embodiments of the present invention will become better understood with regard to the following description in connection with the accompanying drawings. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms, such as, for example, “will,” “will not,” “shall,” “shall not” “must,” and “must not,” are not meant to limit the scope of the present invention as the embodiments disclosed herein are merely exemplary.

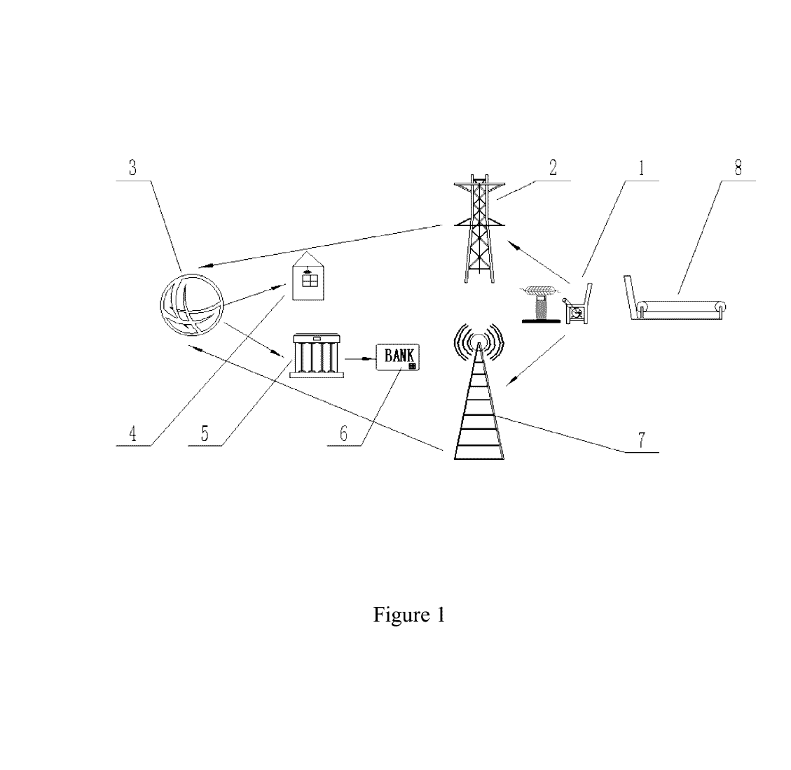

FIG. 1 is an exemplary embodiment of the distributed power generation system, comprising the power generation apparatus 1, the power transmission circuit 2, the data transmission circuit 7, the smart grid 3, other electrical customers 4, a bank 5, and financial compensation 6.

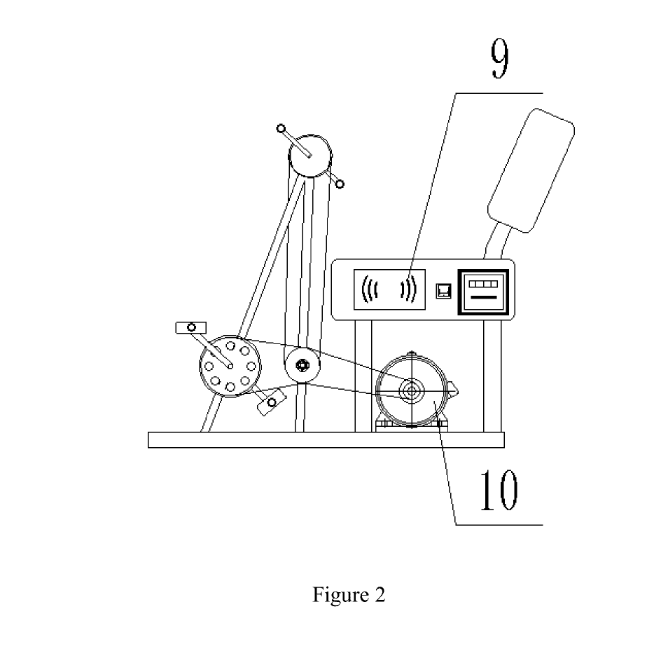

FIG. 2 is an exemplary embodiment of the power generation apparatus comprising the identification circuit 9 and a personal generator 10.

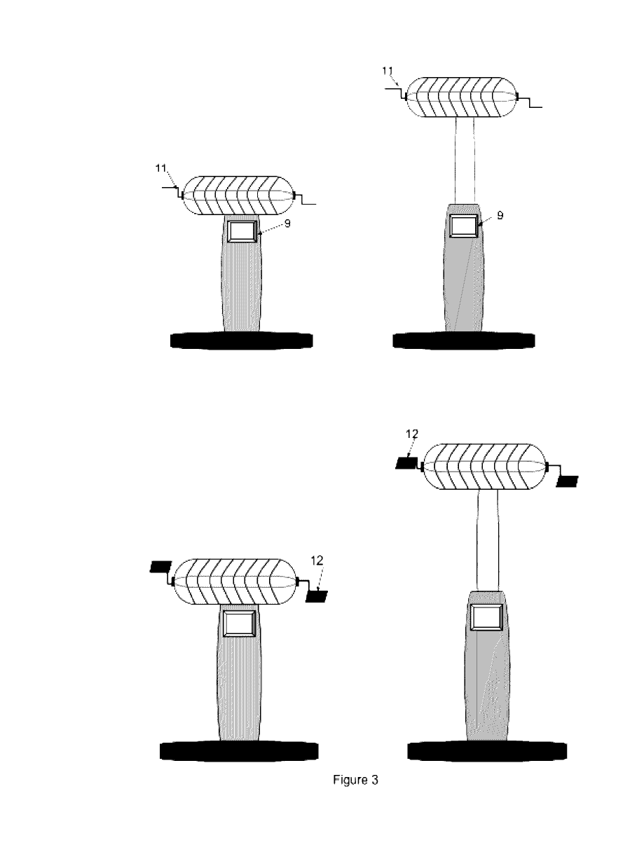

FIG. 3 is an exemplary embodiment of the power generation apparatus comprising the identification circuit 9, the hand pedal 11, and the foot pedal 12.

Referring to FIG. 2, the user inputs their identity information to the identification circuit 9 of the power generation apparatus. In this embodiment, the power generation apparatus is a stationary bicycle exercise apparatus coupled to a personal generator 10. The stationary bicycle exercise apparatus in this embodiment has a seat, foot pedals, and hand pedals all coupled to the power generator 10. The power generation apparatus can wireless communicate with the data transmission circuit 7.

Referring to FIG. 3, the user inputs their identity information to the identification circuit 9 of the power generation apparatus. In this embodiment, the power generation apparatus is a stand along apparatus with adjustment height. The user can either operate it with hands or feet.

The user, employing NFC, RFID, magnetic stripe, or manual entry enters the user's identification information into the identification circuit 9, and begins exercising by physically working the hand pedals and/or foot pedals. The physical work imparted by the user is transmitted to the personal generator 10 by way of belt drive, chain drive, or other means of transmitting physical work as known in the art. The physical work transmitted to the personal generator is converted into electricity and transmitted to the smart grid, and the identity information is also transmitted to the smart grid.

Referring to FIG. 1, after the user has inputted their identification information to the identification circuit and while the user is generating power by imparting physical work on the power generation apparatus 1, the method of power generation and financial compensation performed by the distributed power generation system comprises the following:

The user's identification information is sent via the data transmission circuit 7 to the smart grid 3. The user's identification information can comprise the user's name, billing information, billing address, physical address, social security number, account number, or other personally identifying information. The data transmission circuit 7 can be implemented by wired or wireless communication such as cellular transmission, WiFi, internet, or other means of data transmission.

The smart grid 3, upon receiving the identification information will determine that electricity will be transmitted to the smart grid 3 by the power generation apparatus 1.

The user imparts physical work on the power generation apparatus 1, and the electricity generated by the personal generator will be transmitted to the smart grid 3 via the power transmission circuit 2. The power transmission circuit 2 can be implemented by wires or other techniques to transmit electricity as known in the art.

In FIG. 3, the generator comprising the identification circuit 9, a hand pedal 11, and a foot pedal 12. The height of the vertical frame of the generator can be adjusted for convenience. When one adjusts the generator to a relatively low height, one should use the foot pedal 12 to generate the power. At this point, the generator works as a stationary bicycle. When one adjusts the generator to a high height, one can use the hand pedals 11 to generator the power.

The smart grid 3, upon receiving the transmitted electricity from the power transmission circuit 2, will determine the amount of electricity received from the power generation apparatus 1. This can be measured in watt-hours. Upon receiving electricity from the power generation apparatus 1, the calculated amount of electricity generated by the power generation apparatus 1 will be calculated as a corresponding financial compensation amount. The value of the electricity can be set by market price, by contractual agreement, or by the power company.

The financial compensation amount will be transmitted to the user's bank 5 by the smart grid 3 according to the user's identification information, and the bank will issue financial compensation 6 to the user. The financial compensation amount calculated by the smart grid 3 can be transmitted to the bank 5 by wire transfer, direct deposit, check, or other means of transmitting money. In the above embodiment, this money transfer will be completed automatically.

The financial compensation 6 issued to the user can be paid by debit card, wire transfer, direct deposit, check, or other means of transmitting money.

The smart grid 3 can transmit the received electricity to other electrical customers 4. The transmission of electricity can be done by wire or other techniques of transmitting electricity as known in the art.

Referring to FIG. 1, in another embodiment, a treadmill 8 coupled to a personal generator can be the power generation apparatus. The treadmill 8 functions similarly to the stationary bicycle power generation apparatus 1 in the prior embodiment.

The foregoing description of the preferred embodiments is presented for purposes of illustration and description. It is not intended to be exhaustive or limit the invention to the precise form of the exemplary embodiments disclosed. Many modifications and variations will be apparent to those of ordinary skill in the art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims.

What is claimed is:

1. A distributed power generation system, comprising:
a power generation apparatus, comprising:
an identification circuit, configured to determine a user identity and transmit the user identity;
a personal generator, physically coupled to an exercise equipment, configured to receive physical work from the exercise equipment, convert the physical work to generated electricity, and transmit the generated electricity; and
a smart grid, configured to receive the user identity from the power generation apparatus, receive generated electricity from the power generation apparatus, calculate a financial compensation according to the generated electricity, transmit the financial compensation to a bank according to the user identity, and transmit the generated electricity to a customer.

2. The distributed power generation system of claim 1, wherein the identification circuit determines the user identity using a Near-Field Communication (NFC) protocol, a Radio Frequency Identification (RFID) protocol, a magnetic stripe protocol, or a user-entered data.

3. The distributed power generation system of claim 1, wherein the user identity information comprises a user's personally identifying information and financial information.

4. The distributed power generation system of claim 1, wherein the identification circuit transmits the user identity to the smart grid via a wired or wireless network.

5. The distributed power generation system of claim 1, wherein the personal generator transmits the generated electricity to the smart grid by wire.

6. The distributed power generation system of claim 1, wherein the exercise equipment is manipulated by a user in order for the personal generator to generate electricity, and the user identity corresponds to the user.

7. The distributed power generation system of claim 1, wherein the exercise equipment is a stationary bicycle, or a treadmill.

8. The distributed power generation system of claim 1, wherein the exercise equipment is adjustable in height.

9. A power generation and financial compensation method as applied to a distributed power system comprising a power generation apparatus coupled to a smart grid, the method comprising:
providing the power generation apparatus, comprising an identification circuit and a personal generator physically coupled to an exercise equipment;
determining a user identity of a user of the power generation apparatus from the identification circuit;
transmitting the user identity to the smart grid;
convert physical work to generated electricity, the physical work being done by the user to the power generation apparatus;
transmitting the generated electricity to the smart grid;
calculating a financial compensation amount according to the generated electricity and associating the financial compensation amount with the user identity;
transmitting the financial compensation amount to a bank according to the user identity; and
transmitting the generated electricity to a customer;
wherein, the identification circuit is configured to determine the user identity and transmit the user identity to the smart grid; and the personal generator is configured to receive physical work from the exercise equipment performed by the user, convert the physical work to generated electricity, and transmit the generated electricity to the smart grid.

10. The power generation and financial compensation method of claim 9, wherein the step of determining the user identity is performed using a Near-Field Communication (NFC) protocol, a Radio Frequency Identification (RFID) protocol, a magnetic stripe protocol, or a user-entered data.

11. The power generation and financial compensation method of claim 9, wherein the user identity information comprises a user's personally identifying information and financial information.

12. The power generation and financial compensation method of claim 9, wherein the step of transmitting the user identity to a smart grid is transmitted using a wired or wireless network.

13. The power generation and financial compensation method of claim 9, wherein the step of transmitting the generated electricity is transmitted via a wire to the smart grid.

14. The power generation and financial compensation method of claim 9, wherein the exercise equipment is manipulated by the user in order for the personal generator to generate electricity, and the user identity corresponds to the user.

15. The power generation and financial compensation method of claim 9, wherein the exercise equipment is a stationary bicycle, or a treadmill.

16. The distributed power generation system of claim 9, wherein the exercise equipment is adjustable in height.
